(19) United States
(12) Patent Application Publication
(10) Pub. No.: US 2009/0286462 A1
(43) Pub. Date: Nov. 19, 2009

(54) VENT ASSEMBLY WITH ADJUSTABLE AIR GUIDE VANES

(75) Inventor: Kaoru Goto, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: MORIROKU TECHNOLOGY COMPANY, LTD., Tokyo (JP)

(21) Appl. No.: 12/251,510

(22) Filed: Oct. 15, 2008

(30) Foreign Application Priority Data
Oct. 16, 2007 (JP) 2007-268702

(51) Int. Cl. B60H 1/34

(52) U.S. Cl. 454/155

(57) ABSTRACT

An apparatus for changing the airflow direction at a supply opening for air conditioning. The operational feeling of an operation knob hardly changes an a stable movement of the operation knob is obtained over the entire operation range of the operation knob. As the operation knob reciprocates, the supporting rib linearly contacts an elastic member. Thereby, the supporting rib can retain a stable posture with respect to the elastic member. Consequently, the invariable operational feeling of the operation knob can be obtained over the entire operation range of the operation knob.

### FIELD OF THE INVENTION

The present invention relates to an apparatus for changing the direction of airflow from a supply opening for air conditioning in vehicles and especially, the present invention relates to a vent assembly that is attached to a supply opening for air conditioning in vehicles and is provided with adjustable air guide vanes.

### DESCRIPTION OF THE RELATED ART

An apparatus for changing the direction of airflow from a supply opening for air conditioning, which comprises a plurality of fins for changing the direction of airflow from an air-conditioning duct and a manual operation knob handled by a vehicle driver to change the direction of the fins, has been suggested in the past. For example, Japanese Patent Public Disclosure No. H10-250357 discloses a wind direction adjusting device that is intended to prevent the deterioration of an outside appearance due to use of an operation knob, and to make it possible to reduce the force for handling the operation knob, and the rest.

In the problems to be solved by the wind direction adjusting device mentioned above, the issue of improvement to operationality of the manual operation knob is achieved by a gap, which is formed between the operation knob and an outer surface of a louver, and a supporting member (a rib and/or an elastic member), which abuts on the upper and lower surfaces of the louver in the line contact configuration in the vicinity of the tapered-forward edge of the louver. In other words, the foregoing structure of the wind-direction adjusting device contributes to the stability of supporting the operation knob and the nimble sliding movement of the operation knob.

The supporting member (a rib and/or an elastic member) of the foregoing wind direction adjusting device is attached to the operation knob for changing wind directions and the rib and/or the elastic member are directly in contact with the upper and lower surfaces of the louver around the tapered-forward edge of the louver. Thereby, depending on the surface shape of the louver, the forementioned wind direction adjusting device might have difficulty in creating an invariable operational feeling of the operation knob and providing a stable movement of the operation knob in the entire operation area of the operation knob, that is, over the area where the operation knob reciprocates. In other words, there is a possibility that the forementioned wind direction adjusting device results in limiting a variety of louver design and consequently, results in restricting the capabilities to adjust the direction of wind, because the forementioned wind direction adjusting device inevitably limits the surface shape of louvers that can create an invariable operational feeling of the operation knob and provide a stable movement of the operation knob.

Furthermore, depending on the surface shape of louvers, the forementioned wind direction adjusting device has a possibility of causing uneven abrasion on the rib or the elastic member due to use of the operation knob, because the rib or the elastic member, which is formed on the operation knob, makes direct contact with the upper and lower surfaces of the louver in the vicinity of the tapered-forward edge of the louver so as to hold the operation knob on the louver. When the uneven abrasion of the rib or the elastic member increases, the operational feeling of the operation knob changes.

### SUMMARY OF THE INVENTION

The objective of the present invention is to provide an apparatus for changing the direction of airflow at a supply opening for air conditioning, which prevents the operational feeling of an operation knob from changing due to use of the operation knob.

Another objective of the present invention is to provide an apparatus for changing the direction of airflow from a supply opening for air conditioning, which can create an invariable operational feeling of the operation knob in the entire operation area of the operation knob.

Further objective of the present invention is to provide an apparatus for changing the direction of airflow from a supply opening for air conditioning, which can provide a stable movement of the operation knob in the entire operation area of the operation knob.

The apparatus for changing the direction of airflow from a supply opening for air conditioning according to the present invention comprises: at least one air guide vane disposed in a supply opening for air conditioning, at least one operation knob attached to the air guide vane to reciprocate in the direction of a wingspan of the air guide vane, at least one rotational vane arranged upstream of the air guide vane in the direction of the airflow passing through the air guide vane and adapted to rotate in conjunction with reciprocating motion of the operation knob in order to change the direction of airflow, at least one elastic member secured to the air guide vane, and at least one supporting rib formed on the operation knob, wherein the supporting knob abuts on the elastic member in the line contact configuration, and the supporting rib is adapted to slide on the elastic member with the supporting member being in line contact with the elastic member when the operation knob reciprocates in the direction of a wingspan of the air guide vane.

According to the aforementioned configuration of the apparatus for changing the direction of airflow from a supply opening for air conditioning, the elastic member and the supporting rib can be formed into the optimum size and shape, because the elastic member secured to the air guide vane and the supporting rib formed on the operation knob are in line contact with each other in the direction of reciprocation of the operation knob. Therefore, regardless of the size and shape of the air guide vane, the optimum condition for contact between the elastic member and the supporting rib can be embodied. Consequently, it can be prevented that uneven abrasion is induced on the supporting rib or the elastic member and an operational feeling of the operation knob changes due to use of the operation knob.

The elastic member can be secured to the downstream edge of the air guide vane in the direction of airflow. The elastic member can be fit in a projection formed on the downstream edge of the air guide vane and secured to the air guide vane.

The surface of the elastic member, on which the supporting rib abuts, is preferably composed of a surface that extends in parallel with the direction of movement of the supporting rib when the operation knob reciprocates. The elastic member is made of rubber-based elastic material and preferably made of silicon rubber. The purpose of adopting those constituent element and material is to prevent uneven wear or abrasion of the elastic member and to prevent a change in an operational feeling of the operation knob over the long term.

In the surfaces of the elastic member, especially in the surface of the elastic member, on which the supporting rib abuts, it is preferable to form and distribute microscopic concavities and convexities almost uniformly over the surface. Since the surface of the elastic member, on which the microscopic concavities and convexities are formed, is hardly affected by the microscopic powder that is produced due to the sliding contact of the supporting rib with the elastic member, an operational feeling of the operation knob hardly changes due to use of the operation knob. Consequently, an operational feeling of the operation knob can be maintained substantially constant for a long period of time.

The microscopic concavities and convexities can be formed on the surface of the elastic member by the steps of forming microscopic concavities and convexities by a shot blasting process on the forming surface of the molds for molding the elastic member, and molding the elastic member by the molds and transferring the microscopic concavities and convexities to the surfaces of the elastic member, especially to the surface of the elastic member, on which the supporting rib abuts. According to the aforementioned method for manufacturing the elastic member, homogeneous concavities and convexities can be formed on the elastic member by higher productivity.

The microscopic concavities and convexities on the surface of the elastic member are preferably formed so that the supporting rib can be supported by a number of microscopic concavities and convexities when abutting on the elastic member. The purpose of the supporting structure is to prevent uneven wear or abrasion of the elastic member. In addition, the length of contact between the supporting rib and the elastic member is preferably held constant throughout the entire operation area of the operation knob. In other words, the length of the supporting rib can be adapted to be longer than the length of the operation knob in the direction of reciprocation of the operation knob, because the supporting rib is formed on the operation knob. Consequently, the length of contact between the supporting rib and the elastic member can be held constant throughout the entire operation area of the operation knob and thereby, an invariable operational feeling of the operation knob can be obtained throughout the entire operation area of the operation knob and a stable movement of the operation knob can be made over the entire area where the operation knob reciprocates.

The operation knob is preferably provided with a recess that extends toward the upstream edge of the air guide vane from the downstream edge thereof in the direction of airflow and covers a part of the outer surfaces of the air guide vane. In addition, the elastic member is preferably secured to the downstream edge of the air guide vane.

The supporting rib can be integrally formed on the inner surface of the operation knob. The supporting rib projects into the recess for receiving the air guide vane and extends in the direction of reciprocating motion of the operation knob.

The supporting rib is preferably adapted to abut on the elastic member that is secured to the downstream edge of the air guide vane and extend in parallel with the surface of the elastic member, on which the supporting rib abuts. Simultaneously, the surface of the elastic member, on which the supporting rib abuts, is preferably adapted to form the surface that extends in parallel with the direction of movement of the supporting rib due to the reciprocating motion of the operation knob. The purpose of this structure is to prevent uneven wear or abrasion of the elastic member and obtain an invariable operational feeling of the operation knob for a long period of time.

The operation knob preferably comprises claw portions extending from one side of a wing profile of the air guide vane to the upstream edge face of the air guide vane and slidably engaging with the upstream edge face, and guide protrusions projecting toward the other side of the wing profile of the air guide vane and projecting into the recess for receiving a part of the air guide vane. Thereby, even if the claw portions scratch the upstream edge face of the air guide vane due to the sliding movement of the claw portions, the scratches cannot be seen from the outside of a supply opening for air conditioning. Simultaneously, it is preferred that the other side of the wing profile of the air guide vane is provided with a groove extending in parallel with the surface of the elastic member, on which the supporting rib abuts, and the guide protrusions slidably engages with the groove. Thereby, the guide protrusions and the groove cannot be seen from the outside of a supply opening for air conditioning. Consequently, the appearance of the apparatus for changing the direction of airflow according to the present invention can be improved.

It is preferred that the aforementioned air guide vane is rotatively supported by a rotation shaft extending in the direction of traversing the airflow. It is also preferred that the rotation shaft of the aforementioned rotational vane extends in parallel with the plane that includes the rotation shaft of the air guide vane, and extends at an angle of 90 degrees with the rotation shaft of the air guide vane in the direction of turning clockwise or counterclockwise from the position where the rotation shaft of the rotational vane overlaps the rotation shaft of the air guide vane. Consequently, the rotational vane can change the direction of airflow at 90 degrees to the direction of airflow of the air guide vane. In addition, the present invention can be applied to an apparatus for changing the direction of airflow, wherein an air guide vane to which an operation knob is attached is adapted to be unrotatable and only rotational vanes that are disposed on the upstream side of the air guide vane rotate by reciprocating the operation knob in the direction of a wingspan of the air guide vane.

The air guide vane and the rotational vane may consist of a plurality of fin-shaped members that are arranged at a distance from one another and extending substantially parallel to one another. Simultaneously, a link member can interlock the fin-shaped members of the air guide vane with one another in order that the fin-shaped members may rotate at the same time. Furthermore, another link member can interlock the fin-shaped members of the rotational vane with one another in order that the fin-shaped members of the rotational vane may rotate simultaneously.

These and other advantages or effectiveness of the present invention will be defined from the detailed description of the present invention, which is made with reference to the accompanied drawings.

BRIEF DESCRIPTION OF THE DRAWINGS

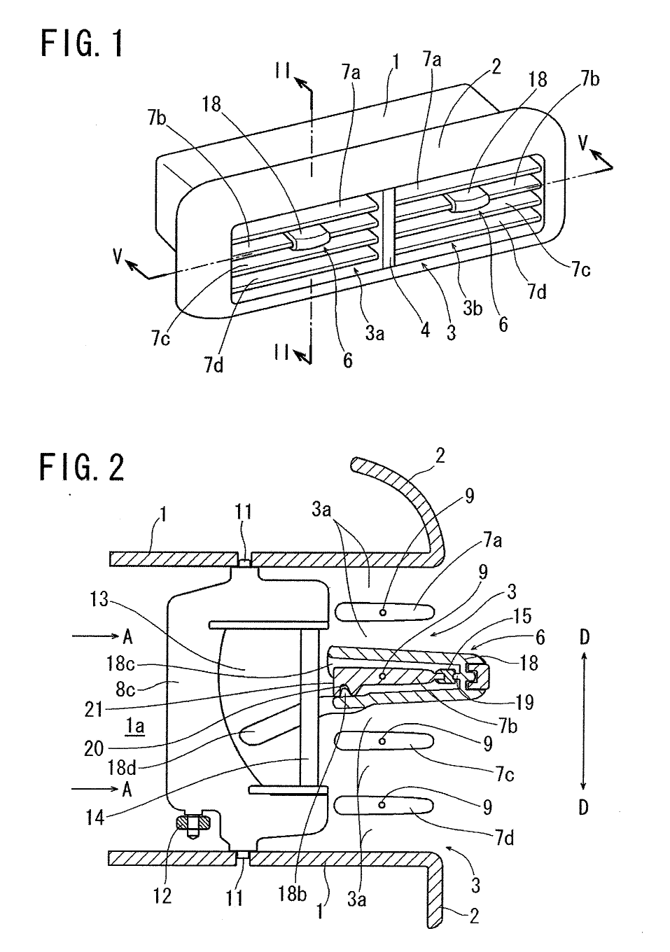

FIG. 1 shows a perspective view of a vent assembly having a supply opening for air conditioning in vehicles, to which the first embodiment of the apparatus for changing the direction of airflow according to the present invention is installed;

FIG. 2 shows a vertical cross-sectional view of the vent assembly taken along a line II-II in FIG. 1;

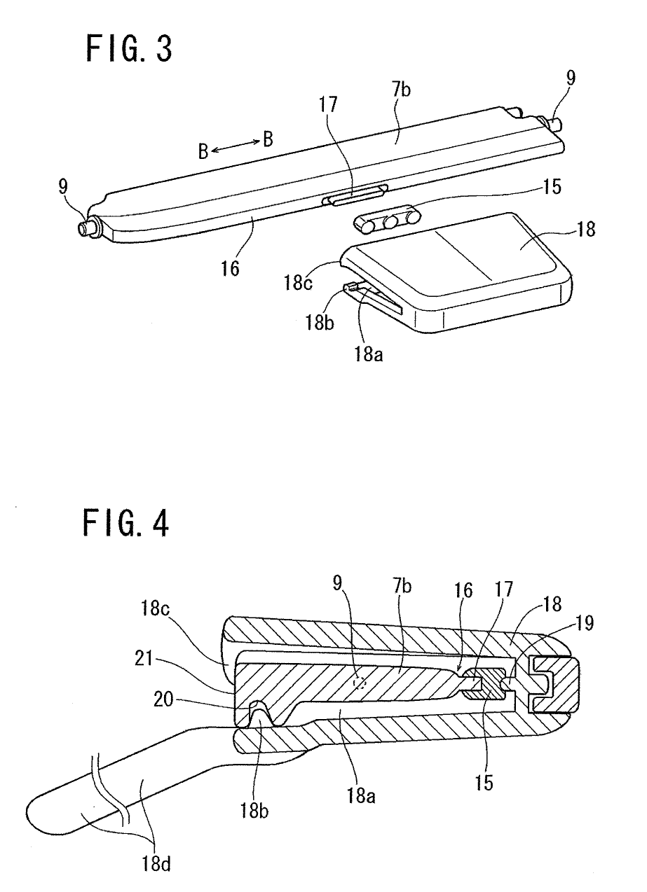

FIG. 3 shows an exploded perspective view of the first embodiment of the apparatus for changing the direction of airflow according to the present invention.

FIG. 4 shows an enlarged sectional view of a portion in the vicinity of the operation knob illustrated in FIG. 2;

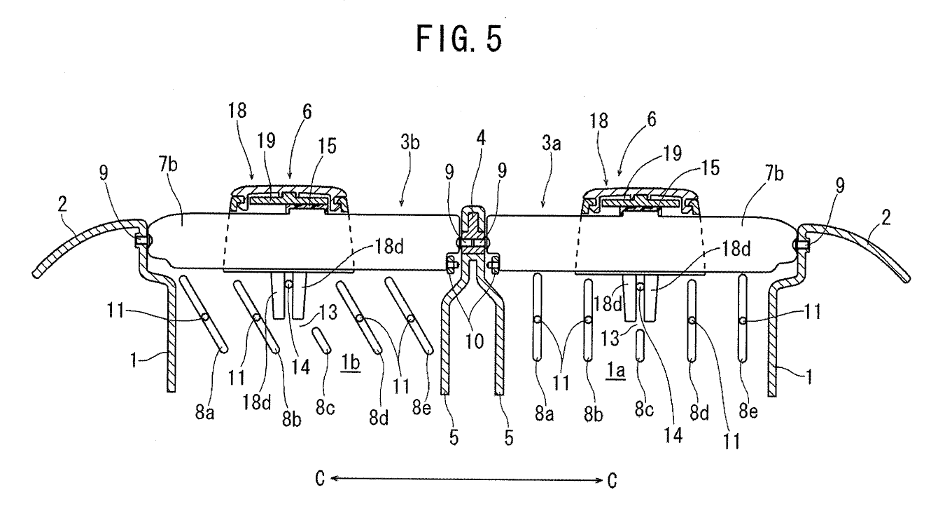

FIG. 5 shows a transverse cross-sectional view of the vent assembly taken along a line V-V in FIG. 1;

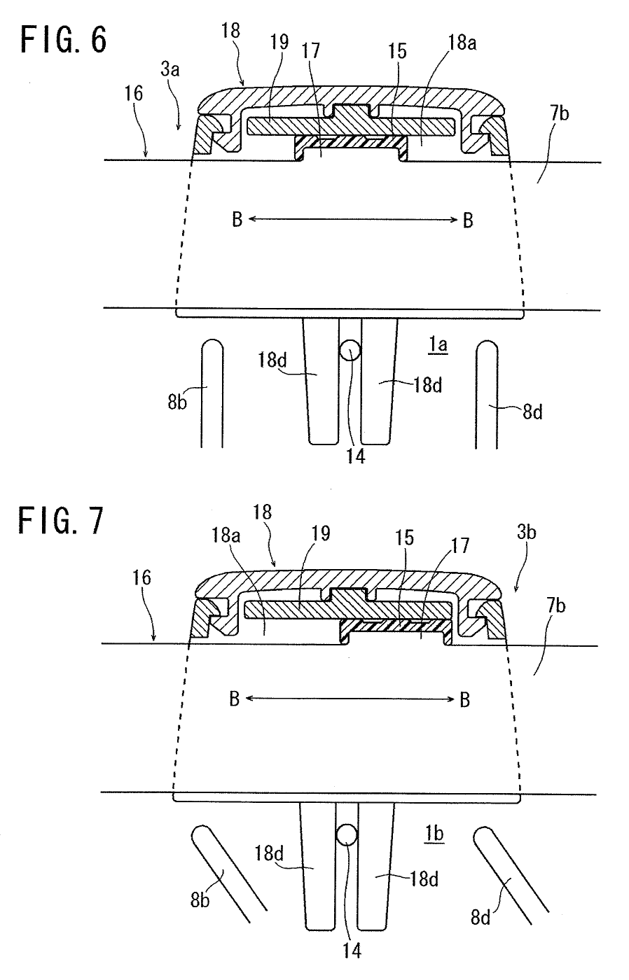

FIG. 6 shows a sectional view of the operation knob on the side of a supply opening 3a in FIG. 5;

FIG. 7 shows a sectional view of the operation knob on the side of a supply opening 3b in FIG. 5;

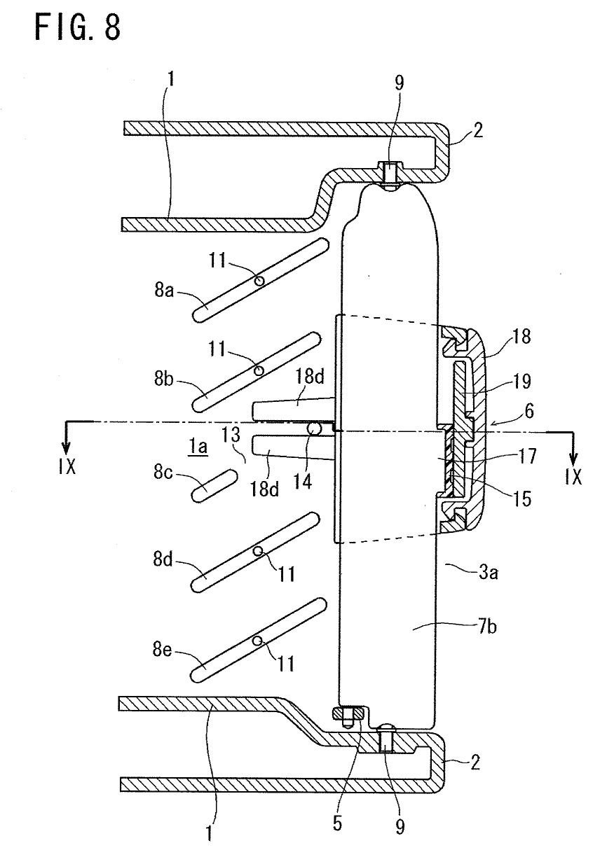

FIG. 8 shows a vertical cross-sectional view of the second embodiment of the present invention, wherein air guide vanes 7a-7d are disposed vertically and rotational vanes 8a-8e are disposed transversely;

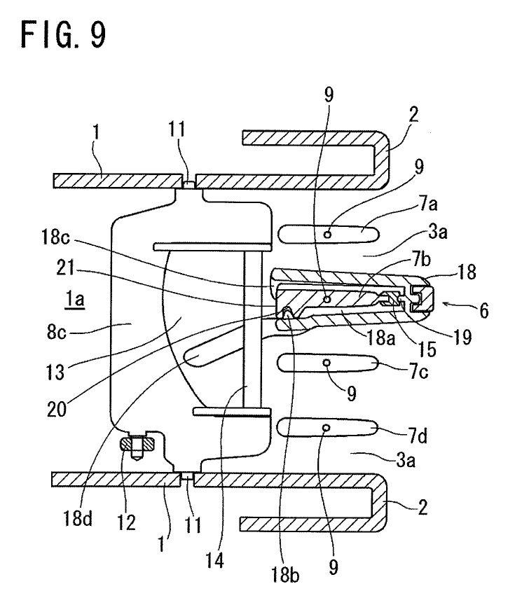

FIG. 9 shows a transverse sectional view taken along a line IX-IX in FIG. 8; and

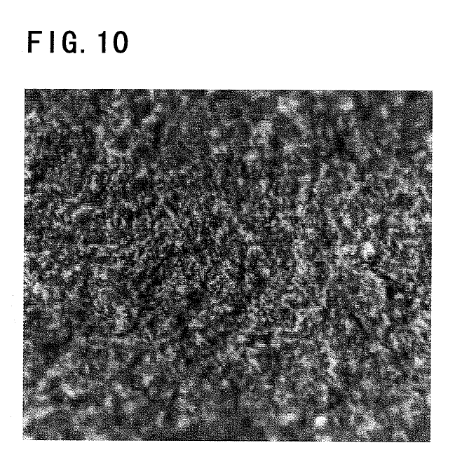

FIG. 10 is a micrograph showing a 500 times magnification of the microscopic concavities and convexities that are formed on the surface of the elastic members used in the first and second embodiments of the present invention.

### DETAILED DESCRIPTION OF THE PREFERRED EMBODIMENTS

### Embodiment 1

FIGS. 1-7 show an embodiment of the present invention in which the apparatus for changing the direction of airflow according to the present invention is installed in a supply opening for air conditioning that opens into a vehicle cabin. A panel portion 2 formed at the end of an air-conditioning duct 1 is provided with an opening 3 and a supporting member 4 is attached in the center of the opening 3. The opening 3 is divided into two supply openings 3a, 3b by the supporting member 4. As shown in FIG. 5, the supporting member 5 is connected to a partition wall 5 that compartments two passageways la, lb in the air-conditioning duct 1. Consequently, the supply opening 3a is communicated with the passageway 1a and the supply opening 3b is communicated with the passageway 1b. The apparatus 6 for changing the direction of airflow according to the present invention is installed in both of the supply opening 3a communicated with the passageway la and the supply opening 3b communicated with the passageway 1b, respectively.

Air guide vanes 7a, 7b, 7c, 7d of each apparatus 6 for changing the direction of airflow extend in the parallel direction, while rotational vanes 8a, 8b, 8c, 8d, 8e disposed on the upstream side of the air guide vanes 7a, 7b, 7c, 7d extend in the vertical direction.

As illustrated in FIGS. 2 and 5, the air guide vanes 7a, 7b, 7c, 7d have a rotation shaft 9, respectively. The air guide vanes 7a, 7b, 7c, 7d are arranged between the panel portion 2 and the supporting member 4 with leaving a space between adjacent air guide vanes in the vertical direction, and are supported by the respective rotation shaft 9 to rotate about the rotation shaft 9 upwardly and downwardly. A link member 10 interlocks the air guide vanes 7a-7d with one another in order that the air guide vanes 7a-7d may rotate simultaneously.

Each of the rotational vanes 8a, 8b, 8c, 8d, and 8e has

a rotation shaft 11 extending in the vertical direction. As illustrated in FIG. 5, the rotation vanes 8a-8e is disposed in the passageways 1a, 1b of the air-conditioning duct 1 with leaving a space between adjacent rotational vanes, and are supported to be rotatable about the respective rotation shaft 11 from side to side. The rotation shaft 11 of each of the rotational vanes 8a-8e extends in parallel with the plane that includes the rotation shafts 9 of the air guide vanes 7a-7d, and extends at an angle of 90 degrees with the rotation shaft 9 of the air guide vanes 7a-7d in the direction of turning clockwise or counterclockwise from the position where the rotation shaft 11 overlaps the rotation shaft 9. A link member 12 interlocks the rotational vanes 8a-8e with one another in order that the rotational vanes 8a-8e each rotate simultaneously. In addition, the rotational vane 8c is provided with an opening 13 and a link member 14 that is adjacent to the opening.

An elastic member 15 is secured to the air guide vane 7b of each of the airflow-direction changing apparatus 6. The elastic member 15 is fit on a projection 17 that is formed at the central portion of the downstream edge 16 of the air guide vane 7b. The projection 17 projects from the downstream edge 16 of the air guide vane 7b in the horizontal direction and the elastic member 15 fit on the projection 17 projects from the downstream edge 16 of the air guide vane 7b in the horizontal direction.

An operation knob 18 is attached to the air guide vane 7b of each of the airflow-direction changing apparatus 6. As illustrated in FIGS. 3 and 4, a recess 18a for receiving an air guide vane is formed in the operation knob 18. In order to attach the operation knob 18 to the air guide vane 7b, the air guide vane 7b is inserted into the recess 18a from the side of the downstream edge 16 of the air guide vane 7b, so that a part of one side of a wing profile of the air guide vane 7b and a part of the other side of the wing profile of the air guide vane 7b as well as a part of the downstream edge 16 of the air guide vane 7b are disposed inside the recess 18a.

A supporting rib 19 is integrally formed on the operation knob 18 to project into the recess 18a. The supporting rib 19 abuts on the elastic member 15 that is secured to the downstream edge 16 of the air guide vane 7b, and the supporting rib 19 is adapted to be slidable on the elastic member 15. As illustrated in FIGS. 2 and 4, the supporting rib 19 can be integrally formed on the inside surface of the operation knob 18 in order that the supporting rib 19 may project into the recess 18a.

In addition, a guide protrusion 18b is formed on the operation knob 18 in order that the guide protrusion 18b may project into the recess 18a. The guide protrusion 18b extends in the direction of reciprocating movement of the operation knob 18 and slidably engages with the groove 20 formed on the underside of the air guide vane 7b. The groove 20 extends in the direction of a wingspan of the air guide vane 7b. In this specification, the direction of a wingspan indicates the direction of B-B in FIG. 3.

Furthermore, a couple of claw portions 18c are formed on the operation knob 18 and these claw portions 18c slidably engage with the upstream edge 21 of the air guide vane 7b.

The operation knob 18 is attached to the air guide vane 7b by means of the supporting rib 19 slidably abutting on the elastic member 15, the guide protrusion 18b slidably engaging with the groove 20 of the air guide vane 7b, and the couple of claw portions 18c slidably engaging with the upstream edge 21 of the air guide vane 7b, in order that the operation knob 18 may slide in the direction of a wingspan of the air guide vane 7b, that is, in the direction of B-B in FIG. 3.

The operation knob 18 is also provided with a couple of lever portions 18d that project toward the rotational vane 8c. The link member 12 of the rotational vane 8c is disposed between those couple of lever portions 18d so that the link member 12 is pinched between the lever portions 18d rotatably and slidably (refer to FIGS. 2, 5 and 7) .

The elastic member 15 may be made of rubber-base elastic material such as silicone rubber. The microscopic concavities and convexities are preferably formed on the surfaces of the elastic member 15, especially on the surface of the elastic member 15 on which the supporting rib 19 slidably abuts. In order to form the microscopic concavities and convexities on the surface of the elastic member 15, the process of shot blasting is applied to the forming surface of the molds (not shown) for molding the elastic member 15 to form the microscopic concavities and convexities on the forming surface of the molds, and the process of molding the elastic member 15 in the molds is carried out. Thereby, the elastic member 15 can be formed into a desired shape simultaneously with transferring the microscopic concavities and convexities on the surface of the forming surface of the molds to the surfaces of the elastic member, especially to the surface of the elastic member, on which the supporting rib abuts.

The surface of the elastic member 15, on which the microscopic concavities and convexities are formed, is hardly affected by the microscopic powder that is produced due to the sliding contact of the supporting rib with the elastic member. Since the supporting rib 19 is supported by a lot of discontinuous microscopic salients, the area of contact between the supporting rib 19 and the elastic member 15 becomes very small and consequently, the microscopic powder that is produced due to abrasion is hardly wedged between the supporting rib 19 and the elastic member 15. Even if the microscopic powder is wedged between the supporting rib 15 and the elastic member 15, the microscopic powder easily falls off from the gap between the supporting rib 19 and the elastic member 15.

Since the surface of the elastic member 15 on which the microscopic concavities and convexities are formed may support the supporting rib 19 through a lot of discontinuous microscopic salients, the discontinuous microscopic salients can present a concentrated load from applying on a part of the surface on which the supporting rib 19 abuts. Thereby, the microscopic concavities and convexities formed on the elastic member 15 can prevent the elastic member 15 from suffering uneven abrasion to the surface. Consequently, a control force of the operation knob 18 hardly changes due to use of the operation knob and an operational feeling of the operation knob 18 can be maintained substantially constant for a long period of time.

FIG. 10 is a micrograph showing a 500 times magnification of the surface of the elastic member 15, on which the microscopic concavities and convexities that are formed. As shown in the micrograph, the microscopic concavities and convexities are distributed almost uniformly over the entire surface and the sliding friction of the supporting rib 19 can be maintained virtually constant over time.

When the operation knob 18 is attached to the air guide vane 7b, the supporting rib 19 abuts on the elastic member 15. Simultaneously, the contact portion between the supporting rib 19 and the elastic member 15 extends linearly in the direction of a wingspan of the air guide vane 7b along which the operation knob 18 reciprocates. Since the supporting rib 19 becomes in line contact with the elastic member 15 as the operation knob 18 reciprocates, the supporting rib 19 can retain a stable posture to the elastic member 15 during the reciprocating movement of the operation knob 18.

If the length of the supporting rib 19 is designed to be longer than the length of the elastic member 15, the contact length between the supporting rib 19 and the elastic member 15 can be retained constant at all times over the entire operation area of the operation knob 18. Due to the aforementioned structure, the operational feeling of the operation knob 18 can be maintained constant over the entire operation area of the operation knob 18 and the movement of the operation knob 18 can be retained stable over the entire operation area of the operation knob 18.

Hereinafter, a brief explanation of working of the above embodiment is given. The ventilation air flowing down in the direction of A of FIG. 2 passes through the rotational vanes 8a-8e and the air guide vanes 7a-7d and runs out from two supply openings 3a, 3b. When the operation knob 18 is slid in the direction of the wingspan, that is, in the direction of B-B at this time, the lever portions 18d of the operation knob 18 provides turning force to the link member 14 of the rotational vane 8c and rotate the rotational vanes 8a-8e at a desired angle in the horizontal direction, that is, in the direction of C-C of FIG. 5. When the operation knob 18 is rotated upwardly and downwardly, that is, in the direction of D-D of FIG. 2, the air guide vanes 7a-7d can be turned at a desired angle upwardly and downwardly. According to the working of the operation knob 18, the air blasting directions of the ventilation air flowing out of the two supply openings 3a, 3b can be changed respectively to a desired direction.

### Embodiment 2

FIGS. 8 and 9 illustrate the other embodiment of the present invention. The features of this embodiment resides in that the air guide vanes 7a-7d are disposed in the vertical direction and the rotational vanes 8a-8e are disposed in the horizontal direction. The apparatus of this embodiment has one supply opening 3a, while the apparatus of embodiment 1 has two supply openings 3a, 3b. The features of embodiment 2 are substantially the same as those of embodiment 1 except for the above-noted structure. The elements that are illustrated in FIGS. 8 and 9 and indicated by the reference numerals commonly used in FIGS. 1-7 are the same elements.

Hereinbefore, the present invention is described by exemplifying the airflow-direction changing apparatus installed in a supply opening for air-conditioning in vehicles. However, the apparatus of the present invention is extensively applicable to a supply opening of an air blower for domestic use and/or business use, without being exclusive to the apparatus for vehicles.

1. An apparatus for changing airflow direction at a supply opening, the apparatus comprising:
at least one air guide vane disposed in the supply opening;
at least one operation knob attached to the air guide vane and reciprocating in a wingspan direction of the air guide vane;
at least one rotational vane disposed on an upstream side with regard to the airflow direction of an airflow passing through the air guide vane, of the air guide vane, and rotating in conjunction with reciprocating movement of the operation knob so as to change the airflow direction;
at least one elastic member secured to the air guide vane; and
at least one supporting rib on the operation knob, in linear contact with the elastic member and linearly sliding on the elastic member as said the operation knob reciprocates in the wingspan direction of the air guide vane.

2. The apparatus as recited in claim 1, wherein the elastic member is secured to a downstream edge of, with regard to the airflow direction of the air guide vane.

3. The apparatus as recited in claim 2, including a projection on the downstream edge of said the air guide vane, wherein the elastic member is fitted into the projection.

4. The apparatus as recited in claim 1, wherein the elastic member has a planar surface which said the supporting rib abuts and which extends parallel to the direction of movement of the supporting rib, as the operation knob reciprocates.

5. The apparatus as recited in claim 1, wherein the elastic member is a rubber-based elastic material.

6. The apparatus as recited in claim 1, wherein the elastic member includes surfaces having microscopic concavities and convexities distributed almost uniformly over the surfaces.

7. The apparatus as recited in claim 6, wherein the microscopic concavities and convexities are formed by a shot blasting surfaces of molds for molding the elastic member, and molding the elastic member, transferring the microscopic concavities and convexities to the surfaces of the elastic member.

8. The apparatus as recited in claim 6, wherein the microscopic concavities and convexities on the surfaces of the elastic member support said the supporting rib through discontinuous microscopic salients when the supporting rib abuts said elastic member.

9. The apparatus as recited in claim 1, wherein contact length between the supporting rib and the elastic member remains constant over an entire operation area of the operation knob.

10. The apparatus as recited in claim 1, wherein the operation knob includes a recess that extends toward an upstream edge of the air guide vane, from a downstream edge of the air guide vane, in the airflow direction and covers a part of outer surfaces of the air guide vane.

11. The apparatus as recited in claim 10, wherein
the supporting rib is integral with an inner surface of said the operation knob, and
the supporting rib projects into the recess for receiving the air guide vane and extends in the direction of reciprocating movement of the operation knob.

12. The apparatus as recited in claim 11, wherein
the supporting rib abuts the elastic member secured to a downstream edge of the air guide vane and extends parallel to a surface of the elastic member, which the supporting rib abuts, and
the surface of the elastic member extends parallel to the direction of movement of the supporting rib when the operation knob reciprocates.

13. The apparatus as recited in claim 12, wherein the operation knob comprises
claw portions extending from a first side of the air guide vane to an upstream edge face of the air guide vane and slidably engaging the upstream edge face,
guide protrusions projecting toward a second side of the air guide vane and projecting into the recess for receiving a part of the air guide vane, and
a groove on the second side of the air guide vane, the groove extending parallel to the surface of the elastic member, which the supporting rib abuts, wherein the guide protrusions slidably engages the groove.

14. The apparatus as recited in claim 1, including a rotation shaft rotably supporting the air guide vane and extending in a direction traversing the airflow direction, a rotation shaft supporting the rotational vane and extending parallel to a plane that includes the rotation shaft supporting the air guide vane and extending at an angle of 90 degrees to the rotation shaft supporting the air guide vane, in the direction of turning from the position where the rotation shaft supporting the rotational vane overlaps the rotation shaft supporting the air guide vane.

15. The apparatus as recited in claim 14, wherein
the air guide vane and the rotational vane include a plurality of fin-shaped members that are located at a distance from one another and extend substantially parallel to one another,
the fin-shaped members of the air guide vane are interlocked by a first link member so that the fin-shaped members rotate simultaneously, and
the fin-shaped members of the rotational vane are interlocked by a second link member so that the fin-shaped members of the rotational vane rotate at the same time.
